(19) United States
(12) Patent Application Publication
(10) Pub. No.: US 2007/0193079 A1
(43) Pub. Date: Aug. 23, 2007

(54) MONEY GREETING CARD STRUCTURE, AND METHODS OF CONSTRUCTING AND UTILIZING SAME

(76) Inventor: CATHY SEPESY, DUNDEE, MI (US)

Correspondence Address: IRVING M. WEINER;WEINER & BURT, P.C., 635 N. US-23, P.O. BOX 186, Harrisville, MI, 48740, US

(21) Appl. No.: 11/306,824

(22) Filed: Jan. 12, 2006

(51) Int. Cl. G09F 1/00

(52) U.S. Cl. 40/124.06

(57) ABSTRACT

A money greeting card structure where the gift of money becomes part of an object or scene in the greeting card.

The present invention relates generally to a money greeting card structure, and methods of constructing and utilizing same.

More particularly, the present invention relates to a money greeting card structure wherein the gift of money becomes part of the object or scene within the greeting card.

### BACKGROUND OF THE INVENTION

The prior, but not necessarily relevant, art is exemplified by: Carroll U.S. Pat. No. 4,890,402; Castro U.S. Pat. No. 6,416,243; and McCahey U.S. Pat. No. 6,422,388.

It is a desideratum of the present invention to avoid the animadversions of the conventional and prior art greeting cards, and to provide a novel and unique money greeting card structure.

### SUMMARY OF THE INVENTION

The present invention provides a money greeting card structure, comprising, in combination: a main greeting card structure provided with a predetermined theme thereon; said predetermined theme including at least one predetermined object and/or at least one predetermined scene; first means forming part of said main greeting card structure for temporarily and removably securing money to said main greeting card structure; and said money becoming part of said predetermined theme by means of at least a portion of said money being visibly exposed to complement and complete said at least one predetermined object and/or said at least one predetermined object.

The present invention also provides a money greeting card structure, comprising, in combination, a main greeting card structure; a predetermined scene and/or object on said main greeting card structure; a paper money bill retaining slot provided in and/or on said predetermined scene and/or object; a paper money bill inserted and temporarily retained in said paper money bill retaining slot so that at least a first portion of said paper money bill becomes part of said predetermined scene and/or object; a backing structure secured to said main greeting card structure; and said backing structure being dimensioned and shaped to cover from view at least a backside of said paper money bill retaining slot and to cover from view and retain therein at least a portion of said paper money bill.

It is a primary object of the present invention to provide a money greeting card structure wherein the gift of money becomes part of the object or scene within the greeting card.

Another object of the present invention is to provide a get well money card where the gift of money becomes part of the object or scene within the card.

A further object of the present invention is to provide a money greeting card structure wherein the greeting card is provided with a different way to present money as a gift.

The term “money” as used herein is intended to cover any form of currency, any form of coupon, any form of gift, any form of I.O.U., a gift certificate, a gift card, and any other forms of traditional money.

Additional objects, features, and advantages of the present invention will occur to those persons skilled in this particular area of technology and to other persons after having been exposed to the present patent application when read in conjunction with the accompanying patent drawings.

### BRIEF DESCRIPTION OF THE DRAWINGS

FIG. 1 illustrates a perspective view of a first embodiment of the present invention.

FIG. 2 shows a partial sectional view taken along the line 2-2 of FIG. 1.

FIG. 3 illustrates a perspective view of a second embodiment of the present invention.

FIG. 4. illustrates a partial sectional view taken along the line 4-4 of FIG. 3.

### DETAILED DESCRIPTION OF THE INVENTION

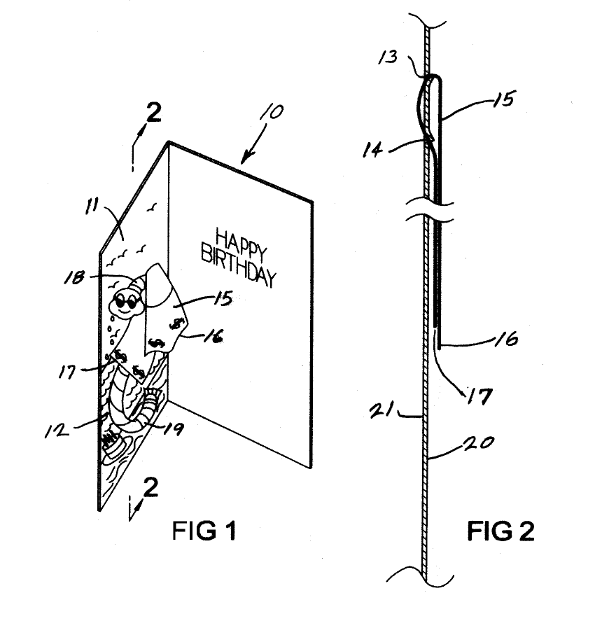

With reference to FIGS. 1 and 2, there is shown a money greeting card structure 10 in accordance with the first embodiment of the present invention.

FIG. 1 shows that the greeting card structure 10 is provided with a predetermined theme 11 including a graphic scene 12.

The greeting card structure 10 is provided with a first surface 20 and a second surface 21.

The greeting card structure 10 is also provided with a first slot 13 and a second slot 14 best viewed in FIG. 2.

The slots 13 and 14 enable money 15 to be passed therethrough so that a first end 16 and a second end 17 of the money 15 are visually exposed to complete the scene 12 as well as forming part of the hat structure 18 of the worm 19 depicted in FIG. 1.

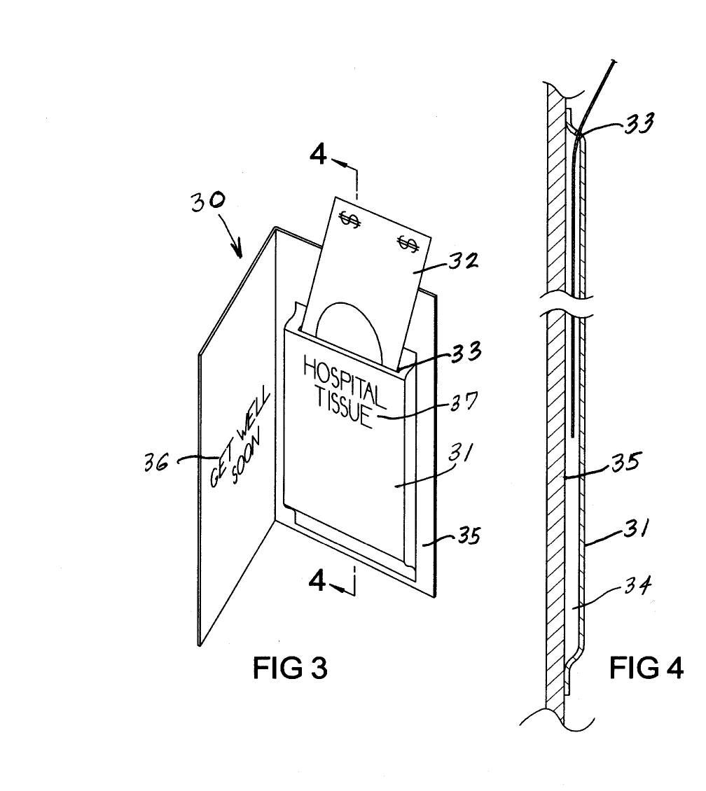

With reference to FIGS. 3 and 4, there is shown a money greeting card structure 30 in accordance with a second embodiment of the present invention.

The money greeting card structure 30 is provided with a predetermined theme 36 including a scene 37 and or an object 31 in the form of a hospital tissue box from which the money 32 extends similar to a facial tissue extending from a tissue box.

As shown best in FIG. 4, there is shown a money-receiving slot 33, and a money receiving space 34 disposed between the greeting card front surface 35 and the object 31 in the form of a hospital tissue box.

There has been illustrated in the accompanying drawings and described hereinabove only two unique and novel embodiments of the present invention which can be practiced and constructed in many different designs, configurations, arrangements of components, sizes, and shapes.

It should be understood that many changes, modifications, variations, and other uses and applications will become apparent to those persons skilled in this particular area of technology and to others after having been exposed to the present patent specification and accompanying drawings.

Any and all such changes, modifications, variations and other uses and applications which do not depart from the spirit and scope of the present invention are therefore covered by and embraced within the present invention and the patent claims set forth hereinbelow.

What is claimed is:

1. A money greeting card structure, comprising, in combination:
a main greeting card structure provided with a predetermined theme thereon;
said predetermined theme including at least one predetermined object and/or at least one predetermined scene;
first means forming part of said main greeting card structure for temporarily and removably securing money to said main greeting card structure; and
said money becoming part of said predetermined theme by means of at least a portion of said money being visibly exposed to complement and complete said at least one predetermined object and/or said at least one predetermined object.

2. A money greeting card structure according to claim 1, wherein:
said main greeting card structure is provided with one or more first surfaces having said predetermined theme thereon;
said main greeting card structure being provided with one or more second surfaces lacking said predetermined theme;
at least one or more slots provided within said main greeting card structure passing from one of said first surfaces to one of said second surfaces and being dimensioned and shaped to permit said money to pass therethrough with at least a portion of said money being visibly exposed in said predetermined scene to complement and complete said predetermined scene.

3. A money greeting card structure according to claim 1, wherein:
said main greeting card structure is provided with one or more first surfaces having said predetermined theme thereon;
said main greeting card structure being provided with one or more second surfaces lacking said predetermined theme;
at least two slots provided within said main greeting card structure passing from one of said first surfaces to one of said second surfaces and being dimensioned and shaped to permit said money to pass therethrough with at least a portion of said money being visibly exposed in said predetermined scene to complement and complete said predetermined scene.

4. A money greeting card structure according to claim 3, wherein:
said two slots are arranged, shaped and dimensioned to permit said money to pass through a first one of said two slots from said first surface to said second surface, and then pass through the second of said two slots from said second surface to said first surface to visually expose a first end of said money and a second end of said money which is remote from first end of said money to complement and complete said predetermined scene on said first surface of said main greeting card structure.

5. A money greeting card structure according to claim 1, wherein:
said main greeting card structure is provided with one or more first surfaces having thereon one or more of said predetermined objects;
said main greeting card structure being provided with one or more second surfaces lacking said one or more predetermined objects;
said predetermined object is permanently affixed to one of said first surfaces of said main greeting card to provide a predetermined space between said first surface and said object;
said predetermined object is provided with one or more slots through which said money may be passed to visually expose at least a portion of said money to complement and complete said predetermined theme.

6. A money greeting card structure, comprising, in combination:
a main greeting card structure;
a predetermined scene and/or object on said main greeting card structure;
a paper money bill retaining slot provided in and/or on said predetermined scene and/or object;
a paper money bill inserted and temporarily retained in said paper money bill retaining slot so that at least a first portion of said paper money bill becomes part of said predetermined scene and/or object;
a backing structure secured to said main greeting card structure; and
said backing structure being dimensioned and shaped to cover from view at least a backside of said paper money bill retaining slot and to cover from view and retain therein at least a portion of said paper money bill.
